(19) United States
(12) Patent Application Publication
(10) Pub. No.: US 2011/0211342 A1
(43) Pub. Date: Sep. 1, 2011

(54) SCREW-IN INDUCTIVE REPLACEMENT LIGHT

(76) Inventor: RUBEN SANDOVAL, REDLANDS, CA (US)

(21) Appl. No.: 13/093,358

(22) Filed: Apr. 25, 2011

Related U.S. Application Data
(63) Continuation-in-part of application No. 12/197,436, filed on Aug. 25, 2008.
(60) Provisional application No. 60/993,559, filed on Sep. 13, 2007.

(51) Int. Cl. F21V 21/00

(52) U.S. Cl. 362/216; 362/382

(57) ABSTRACT

Improvements in a lighting fixture where the lighting fixture uses inductive lighting technology or self ballasting lighting elements with one or a plethora of efficient light elements. The lighting fixture is used where high bay or low bay lighting may be used. The improvement includes a new installation or a retrofit installation. The kit allows a building or residence to use common wiring to secure to a socket. The socket allows for quick installation, upgrading, or replacement with inductive lighting elements. The adapter and the lighting fixture use common pieces that are interchangeable to reduce the number of unique components. The inductive lighting fixture further includes support components that provide structural rigidity to the assembly of components within the socket. The base may further include mounting for a reflective dome to focus or diffuse the light.

### CROSS REFERENCE TO RELATED APPLICATION

This application is a continuation in part of application Ser. No. 12/197,436 filed on Aug. 25, 2008 which claims the benefit of Provisional 60/993,559 filed Sep. 13, 2007 which claims priority to U.S. application Ser. No. 11/282,274 filed Nov. 18, 2005, now U.S. Pat. No. 7,524,083 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in replaceable high by lighting. More particularly the present screw-in inductive replacement light is an adapter for high bay lighting to accept a threaded base inductive lamp.

2. Description of Related Art Including Information Disclosed Under 37 CFR 1.97 and 1.98

Lighting is used to provide light when it is dark or to provide supplemental lighting for a dark area. Often in large buildings, overhead lighting is provided from lights placed near the ceiling of the building and the light is directed downward. Most light bulbs used in these lighting installations are inefficient, and a portion of the energy used in these lights is expended in heat. In the summer, the heat must be cooled with the building air conditioning system. The maintenance cost of these bulbs is also high due to the cost of government imposed lamp disposal fee, the short lifespan and the rapid degradation of 30 to 40% after a year. What is needed is a new lighting fixture that includes a retrofit kit that converts a high bay lighting fixture to a threaded base and further includes an inductive lighting element that can be secured within the retro fit kit. The retrofit kit and or the inductive lighting fixture may further include the dome that can easily be replaced with existing fixtures simply by having a new energy efficient fixture. The invention proposed provides a solution to all the listed requirements.

U.S. Pat. No. 5,497,048 issued to Burd is for a fluorescent bulb that has multiple fluorescent elements located within the light bulb. This invention provides the equivalent energy efficiency and an equivalent amount of light, but the bulb is a custom light bulb, and the light bulb is not manufactured in high volume. The invention does not provide multiple efficient light bulbs that are cost effective and readily available.

U.S. Pat. No. 5,541,477 issued to Maya et al. is for a single fluorescent bulb that also has multiple fluorescent bulb elements that are connected into a single screw-in base. This invention provides the equivalent energy efficiency and the equivalent amount of light, but the bulb is a custom light bulb, and the light bulb is not manufactured in high volume. The invention does not provide multiple efficient light bulbs that are cost effective and readily available.

U.S. Pat. No. 4,664,465 issued to Johnson et al. is for a bulb with a clip attached that allows the bulb to be attached to a metal strip. The patent covers the clip connected to a hollow tube that can extend from a vertical or horizontal surface. This invention uses a single bulb connected to an elongated metal tube or neck. The invention is intended for wiring to an electrical power source. The invention does not include multiple light sockets that connect into a base that can be screwed into a lamp base.

U.S. Pat. No. 6,964,502 issued to Neal R. Verfuerth on Nov. 15, 2005 discloses a retrofit fluorescent light tube fixture apparatus. While this retrofit apparatus that fits into older fluorescent fixtures it simply replaces one fluorescent lighting fixture with another fluorescent lighting fixture that is prone to the same efficiencies and life expectancy of that it replaces.

U.S. Pat. No. 7,070,303 issued to Charles E. Kassey et al. on Jul. 4, 2006 discloses a fluorescent lighting fixture with improved up lighting the bulb receiving portion of the fixture is curved so the outer bulbs have a reflector that is not parallel with the ground. While this configuration provide for more up lighting the illumination elements are still fluorescent bulbs.

The ideal product would allow for modification of a high bay lighting fixture to accept screw-in lighting elements. The ideal product would further include a fixture that accepts inductive lighting elements and creates a threaded base that is securable into the converted lighting fixture.

### BRIEF SUMMARY OF THE INVENTION

It is an objective of the screw-in inductive replacement light to provide an energy efficient lighting system that replaces custom high bay lighting fixtures with a retro fit base that converts the hardwired high bay lighting fixture into a socketed fixture where lighting elements can be quickly installed, replaced or upgraded without requiring the services of an electrician.

It is an objective of the screw-in inductive replacement light to provide an energy efficient lighting system that replaces custom high bay lighting fixtures with an adapter for inductive lamps. The adapter allows for quick changing of inductive lamps to replace, change the output rating and upgrade the lamp as technology improves inductive lighting elements.

The fixture may also include a dome or other reflector or fixture design to focus the light downward. A standard 100-watt incandescent bulb uses 100 watts of energy, a fluorescent light (or inductive light) bulb that provides the same amount of light only requires about 20 to 25 watts of energy. Fluorescent light consume 45 to 50% less energy than a standard incandescent light bulb. The light from fluorescent light is similar or superior to the light from an incandescent light, and can be tinted to provide different shades to simulate other lighting sources. The fixture requires the installation onto the rafters or ceiling of the building where it is installed to produce light that is emitted above and below the lighting fixture as well as out the sides of the lighting fixture. A reflector dome or cover located in the lighting fixture helps to focus the lighting down to where the light is needed. An inductive light source provides an improved lighting source 20 to 30% brighter than standard fluorescent bulbs with increased efficiency and 50% longer bulb life.

A warehouse typically uses 450-465 watt incandescent, halogen or similar light bulb and ballast system. The proposed invention replaces the single 400-watt light bulb with five fluorescent or inductive self ballasting fluorescent lights providing the same or more illumination. The standard warehouse light uses 450-465 watts to produce the light. The five self ballasting fluorescent lights only require 240 to 250 watts of energy. An inductive light source only requires 200 to 220 watts of energy to produce the same amount of illumination, saving 170 to 255 watts of energy that would be spent in heat. A 400 watt metal halide light operates at 1750 degrees of heat, where a fluorescent or inductive lamp operates at 190 to 210 degrees. Inside an air conditioned building the 170 to 255 watts of heat would need to be cooled with the air conditioning system within the building. The savings come from three places, first the more efficient lights, second from air conditioning costs and third, from less maintenance costs. In addition, there can be safety benefits from less ultraviolet rays, and for less chance that the fluorescent bulbs will explode. Inductive lighting provides improved efficiency and savings where a standard warehouse light uses 450-465 watts to produce the light. One to three inductive lights may require as little as 200 watts of energy to produce more light than a standard warehouse light and will provide saving of 250 to 265 watts of energy and 1500 degrees of heat would be spent in heat. Inside an air conditioned building the 1750 degrees of heat would need to be cooled with the air conditioning system within the building. The savings come from three places, first the more efficient lights, and second from air conditioning costs, induction lamps further reduce re-lamping costs by 500%, or mounted separately to 600% reduce, and third the maintenance and government imposed hazardous waste disposal costs.

One problem with placing a torus lighting element within the dome is the shadow that exists from the light of the lighting element blocking the light emitted from the back side of the lighting element. Different light diameters and different dimensions will yield varying reflective angles that will reflect the light from behind the lighting element to the front of the lighting fixture to eliminate the shadow that can be appear under the lighting dome. The internal geometry to minimize or eliminate the shadow. The proposed lighting apparatus minimizes the blocked light by reflecting light around the torus, inductive lighting element.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 is a sectional view of a high bay lighting fixture using inductive lighting elements.

FIG. 2 is a detailed cross sectional view of the lighting fixture from FIG. 7 showing the retaining tab.

FIG. 3 is a perspective view of the lighting fixture showing the arrangement of the components.

FIG. 4 is a view showing the light transmission and reflection rays of the dome and deflector

FIG. 5 is a sectional view of a 2 foot×2 foot lighting fixture using an inductive lighting element.

FIG. 6 is a perspective view looking up into the 2 foot×2 foot inductive lighting fixture.

FIG. 7 shows an exploded perspective view of the components for the screw-in inductive lamp and fixture.

FIG. 8 shows an assembled perspective view of the components for the screw-in inductive lamp and fixture.

FIG. 9 shows a back perspective view of the cap.

FIG. 10 shows a front perspective view of the cap.

FIG. 11 shows a perspective view of the mid base adapter.

FIG. 12 shows a perspective view of the lamp holder.

### DETAILED DESCRIPTION OF THE INVENTION

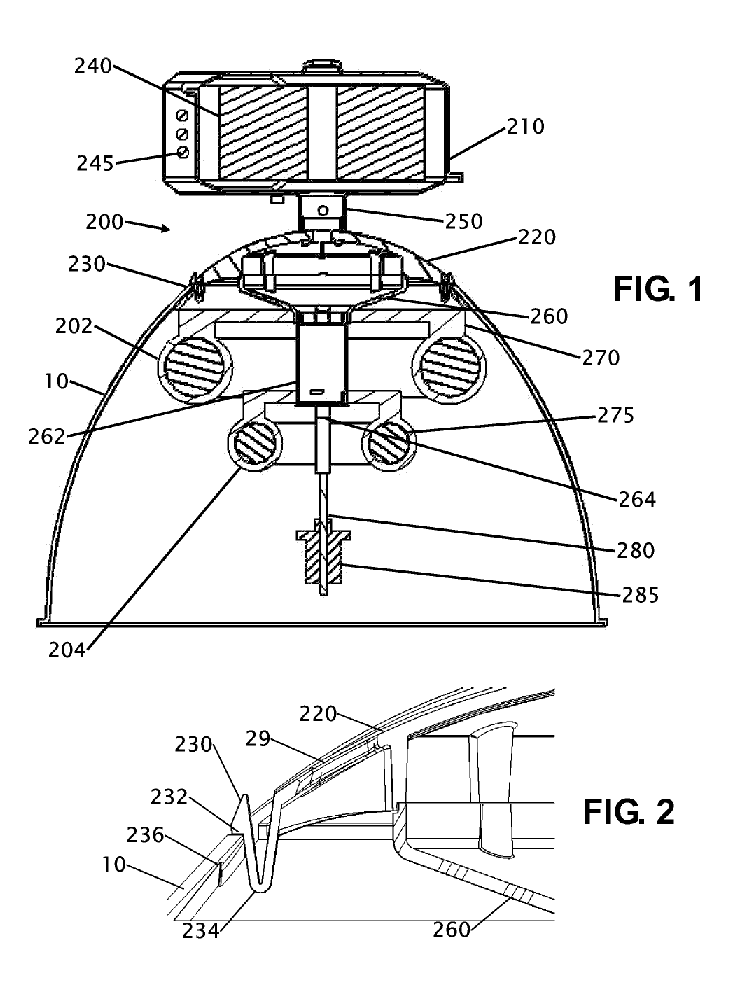

FIG. 1 shows a sectional view of a bay lighting fixture using inductive lighting elements 200. The reflective or focusing dome 10 directs light from the lighting elements 202 and 204 downward so more of the light shines where desired. This figure show two lighting elements of different size, but the size, shape and output illumination of the lighting elements can be the same or different depending upon the desired amount of light that is required. The reflective or focusing dome 10 is attached to the housing with clips or fasteners 230. The dome rests on the dome retainer 220, where gravity and the retaining tab 230 lock the dome in place. The shape and configuration of these clips is shown and described in more detail with FIG. 2 below. The dome retainer is connected or integrated with a connecting tube 250 that supports the lighting and dome in addition to providing a conduit for wiring. The connecting tube 250 is attached to the ballast enclosure. In some configurations contemplated, the ballast box may be empty, when the ballast is included with the lighting elements. The ballast 240 is shown housed in the ballast box 210. One configuration of electrical connection to the ballast is with screw terminals 245, but the wiring connection(s) could be made with wire nuts or spring clips where the wires are pushed into the terminals and retained by spring force that both retain the wires and provide electrical connection between the ballast and the external wiring. An electrical connection from the ballast extends through connecting tube 250, into the dome retainer 220 for connection with the lighting elements 202, 204 or lighting socket for the lighting elements. Locking bars 270 and 275 hold the inductive lighting elements in place within the dome and on the lower cover 260 that is capped with an extender 262, and an extender cap 264. The extender allows the placement and retention of the additional lighting element 204 that holds locking bar 275.

A lower cover 260 encloses the lower portion of the housing to protect the electrical wiring. The ballast box 210, dome retainer 220, and the lower cover 260 can be fabricated using a number of different methods including but not limited to casting, machining, drawing, forming or molding. In the preferred embodiment the part are made from an injection molded process. The materials for these components can also be variety of types including but not limited to plastics, resins, ceramic, ferrous and non-ferrous materials, with the qualities of strength, heat resistance. A safety locking mechanism 285 is installed on the end of retaining cable 280 to hold the light fixture in position. While in this figure the retaining mechanism 285 is shown extended from the cable 280, upon installation the safety device is secured against the bottom of the lighting fixture.

FIG. 2 is a detailed cross-sectional view of the lighting fixture from FIG. 1 showing the retaining tab 230. The reflective or focusing dome 10 is shown resting upon a portion of the dome retainer 220. For installation, the dome is brought over the dome retainer 220, the retaining tabs 230 will flex inward from the hinge area 234 allowing the dome 10 to pass by the clip, and then spring back into position locking the dome 10 under the tab at point 232. Once the dome is in position, gravity, in addition to the clips 230 will keep the dome resting on the dome retainer at location 236 and all around the dome retainer. The lower housing 260 is shown in position under the dome retainer protecting the wiring connections. Vent 29 is shown in this view as it passes through the dome retainer. The vents are a critical part of the design because they allow heat from the room and from the lights to vent out of the fixture.

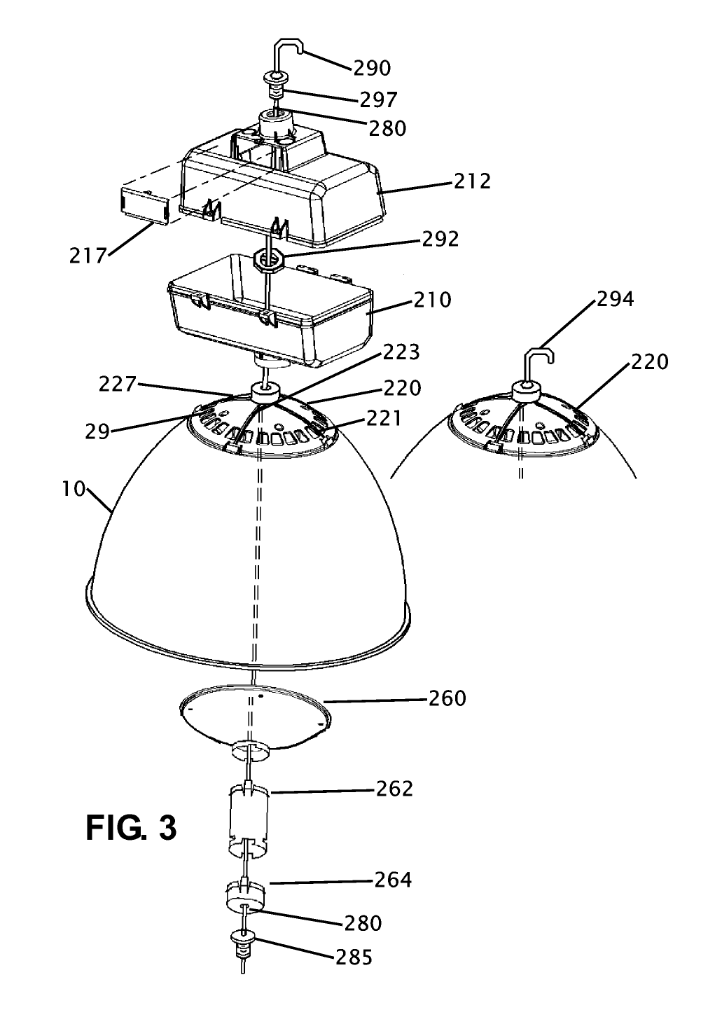

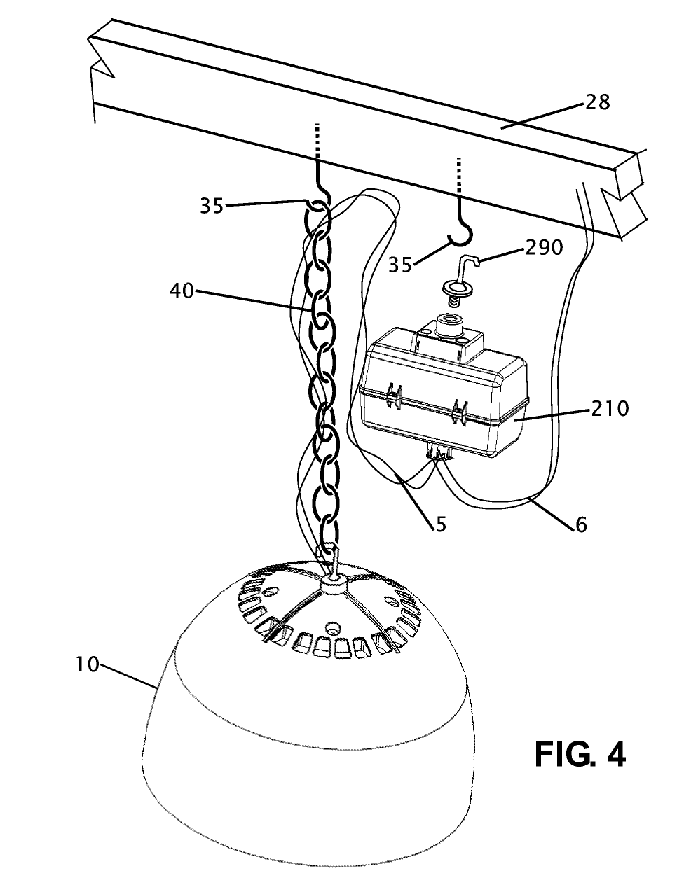

FIG. 3 is a perspective view of the lighting fixture showing the arrangement of the components. A retaining cable 280 passes through the entire lighting fixture and is secured with a safety line 285 located at the end of the cable. The top portion of the cable 280 is attached to a hook 290 that can be secured to the ceiling or joists of a building. The bottom portion 297 of the hanging hook 290 is secured to the ballast box with a nut 292 that is threaded onto the end of the hook at 297 from inside the ballast box. In an alternate mounting embodiment the hook 294 is connected to the top of the dome retainer 220. The dome 10 is shown below the dome retainer 220. A seams 221, 223, 227 are shown in this figure. The seam allows the dome retainer to be fabricated in multiple sections that can be connected. In the embodiment shown, the dome retainer is made from four pieces. In another contemplated embodiment, the dome retainer and at least a portion of the ballast box is made from a single component. The enclosure for ballast is shown located above the lighting fixture with a top housing 212, of the ballast box 210 and an access cover 217. In this embodiment the top and bottom housings are connected with a hinged arrangement with a closure. In yet another contemplated embodiment, the ballast box dome retainer and connecting pipe are made in two halves. This view shows the dome retainer essentially as a dish shape but other similar shapes can be used. The lower cover 260 is shown under the dome and it is attached to the dome retainer. The design of the lower cover is critical to the transmission of light around the lighting element(s). A description of the design requirement to reflect light around the lighting elements is shown and described with FIG. 4. The extender 262 is shown below the lower cover and attaches to the lower cover. The extender cap 264 is shown below the extender and closes the opening in the bottom of the extender 262.

The disk shape is ideal because it allows for any heat to be channeled up through the lighting fixture. Vents 29 are shown around the dome retainer. In the embodiment shown the vents are essentially rectangular in shape, but other shapes are contemplated to include but not be limited to rectangular, circular, elliptical vents or combination thereof.

FIG. 4 is an isometric view of a one piece light dome 10 with a separate ballast box 210. In this embodiment the dome is cast from a clear, multi-colored, translucent, or opaque material and is then internally coated or painted with an aluminum or chrome to provide a reflective surface. The dome is made from a polycarbonate abs or other similar material as opposed to being cast or spun out of aluminum or other metal. The ballast box 210 is shown mounted separately from the lighting dome, and prototypes have been made with a separation of 15 feet between the ballast and the lighting elements. The wiring from the buildings electrical system 6 enters into the ballast box 210 and, after the voltage is converted, a separate set of wiring 5 connects to the lighting fixture 10. This entire lighting system is attached to the ceiling or joist 28 of the building from hooks 35, chain 40 and or hooks integrated into the lighting or ballast enclosure 290.

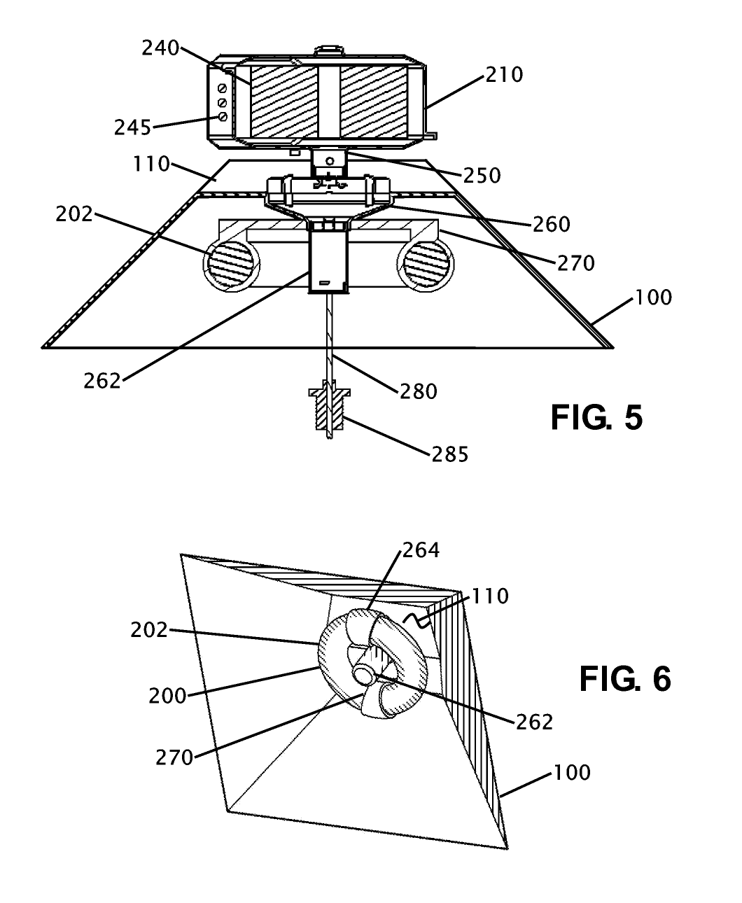

FIG. 5 is a sectional view of a 2 foot×2 foot lighting fixture 200 using an inductive lighting element. While the majority of fluorescent fixtures are configured in a 2 foot by four foot configuration a number of fluorescent fixtures are 2 foot by 2 foot in size. In this embodiment the reflector is a bent reflector 100 is formed from sheet metal. The inside surface of this reflector is preferably painted white or other similar reflective color or a silver color to reflect the light. The inductive lighting element 202 is attached to the bent reflector with clips or fasteners. It is also contemplated that the lighting fixture is clamped through the bent reflector 100 using the cover and the ballast box.

The connecting tube 250 is attached to the ballast enclosure. In some configurations contemplated, the ballast box may be empty, when the ballast is included with the lighting elements. The ballast 240 is shown housed in the ballast box 210. One configuration of electrical connection to the ballast is with screw terminals 245, but the wiring connection(s) could be made with wire nuts or spring clips where the wires are pushed into the terminals and retained by spring force that both retain the wires and provide electrical connection between the ballast and the external wiring. An electrical connection from the ballast extends through connecting tube 250, into the dome retainer 220 for connection with the lighting elements 202 or lighting socket for the lighting elements. In the preferred embodiment the lighting element is torus shaped. Locking bars 270 hold the inductive lighting elements in place within the dome and on the lower cover 260 that is capped with an extender 262.

A lower cover 260 encloses the lower portion of the housing to protect the electrical wiring. The materials for these components can also be variety of types including but not limited to plastics, resins, ceramic, ferrous and non-ferrous materials, with the qualities of strength, heat resistance. A safety locking mechanism 285 is installed on the end of retaining cable 280 to hold the light fixture in position. While in this figure the retaining mechanism 285 is shown extended from the cable 280, upon installation the safety device is secured against the bottom of the lighting fixture.

FIG. 6 is a perspective view looking up into the 2 foot×2 foot inductive lighting fixture. The fixture is constructed with a bent metal reflector 100. While a bent metal reflector is shown and described, because it is the most common and cost effective, other materials are contemplated including but not limited to glass, paper and plastics. The sides of the reflector 100 are bent to ensure more of the light shines downward. Inside the reflector the top of the fixture has an inside bend 110 to spread the light from the top of the inductive lighting element 202. This figure shows the electromagnet(s) 160 that encircle a portion of the illumination torus. The end of the extender 262 can be seen extending through the inductive lighting element 202. Locking bar(s) 270 hold the inductive lightning element 202 in the fixture and provide some protection from vibration and shock.

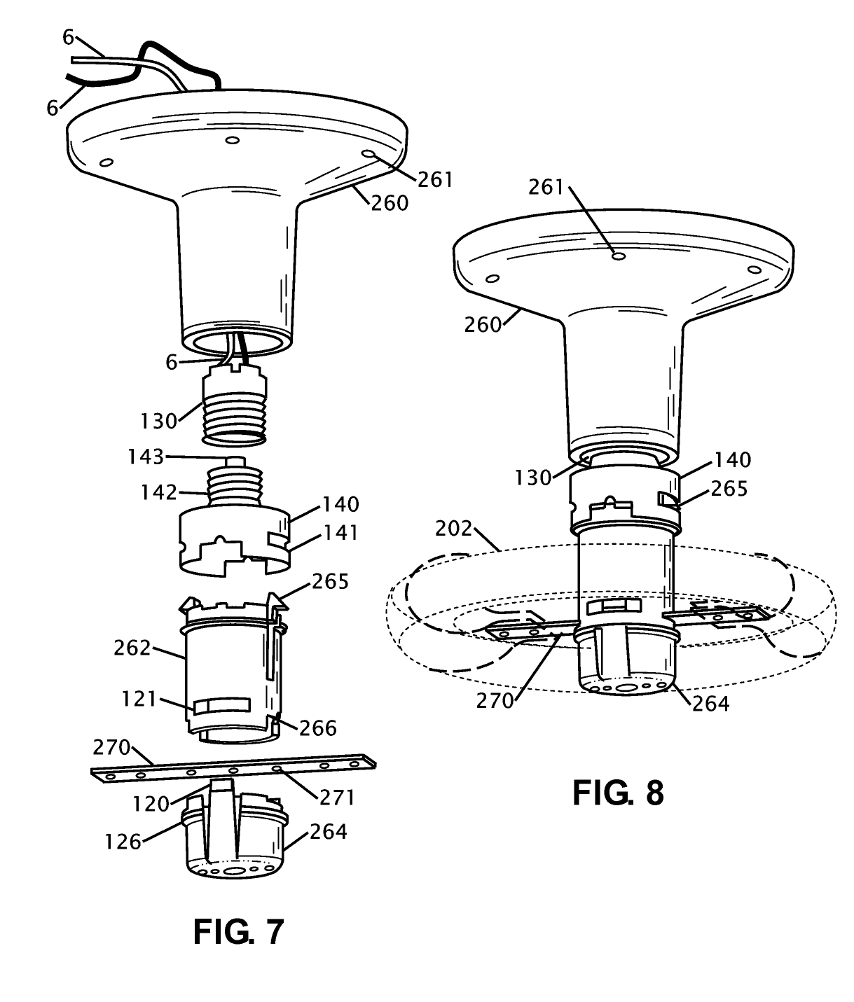

FIG. 7 shows an exploded perspective view of the components for the screw-in inductive lamp and fixture. FIG. 8 shows an assembled perspective view of the components for the screw-in inductive lamp and fixture. In this preferred embodiment the fixture is actually two assemblies that convert the wiring 6 of a structure to accept a first threaded base 130. A mating second threaded base 142 allows for an inductive lighting element to be secured into the first threaded base. From these FIGS. 7 and 8 wiring 6 from the building or structures' electrical system is brought in the lower cover 260. This lower cover is the same component that is shown and described in FIGS. 1 and 5. The lower cover 260 has a plurality of mounting holes 261 that allows the lower cover to be secured to an electrical junction box on a ceiling, wall or other structural support. An extender cap 264 is secured into the lower cover 260.

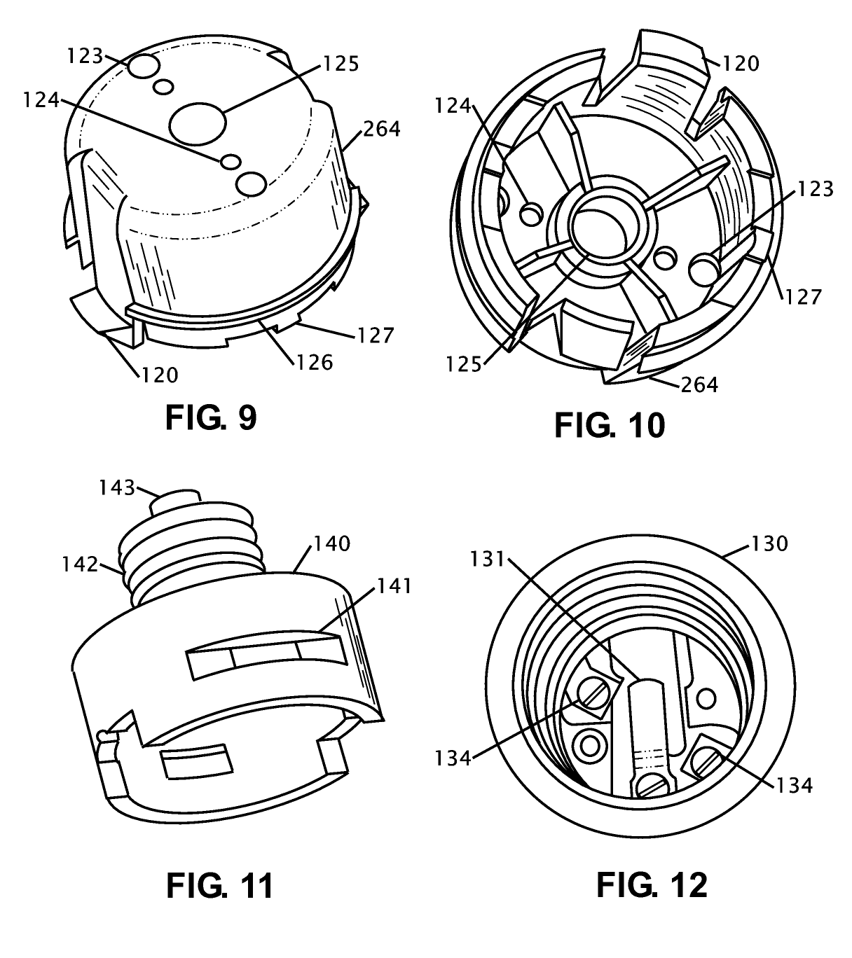

The extender cap 264 is used in two placed in FIGS. 7 and 8. The extender cap is shown and described in more detail in FIGS. 9 and 10 where FIG. 9 shows a back perspective view of the cap while FIG. 10 shows a front perspective view of the cap. The extender cap 264 has hook tabs 120 that engage into openings 121 in the extender 262. The extender cap 264 further has an annular lip 126 that limits how far the extender cap 264 can be inserted into the extender 262. The extender cap 264 has a central hole 125 for electrical wires to pass through the extender cap 264. The extender cap 264 further has two pairs of holes 123 and 124 that are sized to accept #6 screws 124 and #8 screws 123. When screws are placed through the appropriate holes a lamp holder with bushings 130 is secured to the extender cap 264.

FIG. 12 shows a perspective view of the lamp holder 130. The lamp holder 130 has an internal threaded socket that accepts a typical household threaded lamp. The lamp holder is secured to the extender cap 264 using screws that secure the lamp holder 130 in the #6-32 retaining holes with screws 134. The electrical wiring connects to conductor 131 and the internal thread area. An adapter mid base adapter 140 is threaded into the lamp holder 130 to provide electrical connection to a lighting element 202.

FIG. 11 shows a perspective view of the mid base adapter 140. The mid base adapter 140 has an end conductor 143 that connects to the conductor 131 in the lamp holder 130. The threaded base 142 of the mid base adapter 140 makes contact with the mating threads of the lamp holder 130. A plurality of side openings 141 in the mid base adapter provide openings for the hook tabs 265 of the extender 262 to engage into.

The extender 262 extends and connects the mid base adapter 140 to a second extender cap 264. A locking bar 270 is captured between the mid base adapter 140 and the extender cap 264 in a saddle area 266 in the extender and with a complimentary saddle in the extender cap 264. Locating holes 271 in the locking bar 270 are located onto tabs 127 (shown in FIGS. 9 and 10) to locate, position and secure the locking bar from movement.

Thus, specific embodiments of a screw-in inductive replacement light have been disclosed. It should be apparent, however, to those skilled in the art that many more modifications besides those described are possible without departing from the inventive concepts herein. The inventive subject matter, therefore, is not to be restricted except in the spirit of the appended claims.

1. A screw-in inductive replacement light comprising:
a cover configured for mounting on an essentially flat surface wherein said cover includes a base adapter having electrical connections for electrical wiring and said base being configured for a lamp holder;
a lamp holder configured for secure engagement with said base adapter;
said lamp holder being configured for securing a locking bar that extends through said lamp holder, and
an inductive lighting element that is secured to said lamp holder.

2. The screw-in inductive replacement light according to claim 1 that further includes an extender.

3. The screw-in inductive replacement light according to claim 1 wherein said cover further includes a plurality of mounting holes.

4. The screw-in inductive replacement light according to claim 1 wherein said lamp holder further includes an extender cap.

5. The screw-in inductive replacement light according to claim 4 wherein said extender cap includes a saddle area for securing said locking bar.

6. The screw-in inductive replacement light according to claim 1 wherein said lamp holder is configured as a medium, medium skirt, plug in, candelabra or bayonet base.

7. The screw-in inductive replacement light according to claim 1 wherein said base adapter is configured as a medium, medium skirt, plug in, candelabra or bayonet base.

8. The screw-in inductive replacement light according to claim 1 wherein said extender cap has further includes a plurality of mounting holes that secure said base adapter to said lamp holder.

9. The screw-in inductive replacement light according to claim 1 wherein said base adapter further includes a reflective dome.

10. The screw-in inductive replacement light according to claim 1 wherein said inductive lighting element is torus shaped.

11. A screw-in inductive replaceable light comprising:
a lamp holder having a threaded base;
said lamp holder being configured for securing a locking bar that extends through said lamp holder, and
an inductive lighting element that is secured to said lamp holder.

12. The screw-in inductive replaceable light according to claim 11 that further includes an extender.

13. The screw-in inductive replaceable light according to claim 11 wherein said cover further includes a plurality of mounting holes.

14. The screw-in inductive replaceable light according to claim 11 wherein said lamp holder further includes an extender cap.

15. The screw-in inductive replaceable light according to claim 14 wherein said extender cap includes a saddle area for securing said locking bar.

16. The screw-in inductive replaceable light according to claim 11 wherein said lamp holder is configured as a medium, medium skirt, plug in, candelabra or bayonet base.

17. The screw-in inductive replaceable light according to claim 11 wherein said extender cap has further includes a plurality of mounting holes that secure said base adapter to said lamp holder.

18. The screw-in inductive replaceable light according to claim 11 wherein said inductive lighting element is torus shaped.

19. The screw-in inductive replaceable light according to claim 12 wherein said extender is secured to said lamp holder with a plurality of engaging hook tabs.

20. The screw-in inductive replaceable light according to claim 11 wherein said locking bar has a plurality of locating holes that locates and locks said locking bar in said lamp holder.
